(19) United States
(12) Patent Application Publication
(10) Pub. No.: US 2025/0380244 A1
(43) Pub. Date: Dec. 11, 2025

(54) USER-EQUIPMENT-SELECTED RESOURCE SKIPPING CONFIGURATION

(71) Applicant: QUALCOMM Incorporated, San Diego, CA (US)

(72) Inventors: Diana MAAMARI, San Diego, CA (US); Gabi SARKIS, San Diego, CA (US); Mickael MONDET, Louannec (FR); Prasada Veera Reddy KADIRI, San Diego, CA (US); Huilin XU, Temecula, CA (US); Le LIU, San Jose, CA (US); Weimin DUAN, San Diego, CA (US)

(21) Appl. No.: 18/738,460

(22) Filed: Jun. 10, 2024

(51) Int. Cl. H04W 72/04; H04W 72/231

(52) U.S. Cl. CPC H04W 72/04; H04W 72/231

(57) ABSTRACT

Various aspects of the present disclosure generally relate to wireless communication. In some aspects, a user equipment (UE) may receive a first indication of one or more resource allocations that are assigned to the UE. The UE may transmit a second indication of a UE-selected resource skipping configuration that is based at least in part on the one or more resource allocations. Numerous other aspects are described.

### FIELD OF THE DISCLOSURE

Aspects of the present disclosure generally relate to wireless communication and specifically relate to techniques, apparatuses, and methods for user-equipment-selected resource skipping configuration.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving a first indication of one or more resource allocations that are assigned to the UE. The method may include transmitting a second indication of a UE-selected resource skipping configuration that is based at least in part on the one or more resource allocations.

Some aspects described herein relate to a method of wireless communication performed by a network node. The method may include transmitting a first indication of one or more resource allocations that are assigned to a UE. The method may include receiving a second indication of a UE-selected resource skipping configuration that is based at least in part on the one or more resource allocations.

Some aspects described herein relate to an apparatus for wireless communication at a UE. The apparatus may include one or more memories and one or more processors coupled to the one or more memories. The one or more processors may be configured to receive a first indication of one or more resource allocations that are assigned to the UE. The one or more processors may be configured to transmit a second indication of a UE-selected resource skipping configuration that is based at least in part on the one or more resource allocations.

Some aspects described herein relate to an apparatus for wireless communication at a network node. The apparatus may include one or more memories and one or more processors coupled to the one or more memories. The one or more processors may be configured to transmit a first indication of one or more resource allocations that are assigned to a UE. The one or more processors may be configured to receive a second indication of a UE-selected resource skipping configuration that is based at least in part on the one or more resource allocations.

Some aspects described herein relate to a non-transitory computer-readable medium that stores a set of instructions for wireless communication by a UE. The set of instructions, when executed by one or more processors of the UE, may cause the UE to receive a first indication of one or more resource allocations that are assigned to the UE. The set of instructions, when executed by one or more processors of the UE, may cause the UE to transmit a second indication of a UE-selected resource skipping configuration that is based at least in part on the one or more resource allocations.

Some aspects described herein relate to a non-transitory computer-readable medium that stores a set of instructions for wireless communication by a network node. The set of instructions, when executed by one or more processors of the network node, may cause the network node to transmit a first indication of one or more resource allocations that are assigned to a UE. The set of instructions, when executed by one or more processors of the network node, may cause the network node to receive a second indication of a UE-selected resource skipping configuration that is based at least in part on the one or more resource allocations.

Some aspects described herein relate to an apparatus for wireless communication. The apparatus may include means for receiving a first indication of one or more resource allocations that are assigned to the UE. The apparatus may include means for transmitting a second indication of a UE-selected resource skipping configuration that is based at least in part on the one or more resource allocations.

Some aspects described herein relate to an apparatus for wireless communication. The apparatus may include means for transmitting a first indication of one or more resource allocations that are assigned to a UE. The apparatus may include means for receiving a second indication of a UE-selected resource skipping configuration that is based at least in part on the one or more resource allocations.

While aspects and embodiments are described in this application by illustration to some examples, those skilled in the art will understand that additional implementations and use cases may come about in many different arrangements and scenarios. Innovations described herein may be implemented across many differing platform types. devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, RF-chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating a first example and a second example of one or more UEs that are implemented in the form of an extended reality device, in accordance with the present disclosure.

FIG. 5 is a diagram illustrating an example of uplink a configured grant (CG) communication, in accordance with the present disclosure.

FIGS. 6A-6B are diagrams illustrating examples of unused transmission occasion-uplink control indication for indicating unused uplink CG physical uplink shared channel occasions, in accordance with the present disclosure.

FIG. 7 is a diagram illustrating an example of a wireless communication process between a network node and a UE, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless network may support unused transmission opportunity-uplink control information (UTO-UCI) to allow a user equipment (UE) to indicate one or more unused transmission occasions and thereby avoid or mitigate wasted uplink resources. For example, a UE may be allocated a configured grant (CG) that includes multiple physical uplink shared channel (PUSCH) transmission occasions that are allocated to the UE. In some aspects, the UE may determine that a future transmission occasion will not be used by the UE, and the UE may transmit UTO-UCI to indicate the unused transmission occasion to a network node and enable the network node to reallocate the associated air interface resources to another device.

At times, a network node may configure UTO-UCI operation at a UE, such as by transmitting one or more UTO configuration parameters via radio resource control (RRC) signaling. To illustrate, the network node may configure a number of bits that are used by a bitmap that indicate whether the next valid transmission occasions will be used or skipped and/or may configure whether a particular CG assigned to the UE includes UTO operation. However, a network node configuring UTO operation at a UE may lead to inefficiencies (e.g., resource waste and/or air interface resources that are unused by the UE and are not reallocated by the network node), where “UTO operation” may denote enabling, configuring, and/or using UTO-UCI communications. To illustrate, the UE may have information that is unavailable to the network node (e.g., UE-local information), such as an uplink data traffic profile that may be characterized by a data packet size, a data packet frequency, and/or number of data packets, that may impact an efficiency of UTO operation at the UE as described below. Other examples of UE-local information that may impact an efficiency of UTO operation at a UE include a local data packet mapping algorithm and/or a data packet bundling prioritization. Alternatively, or additionally, the UE may include an ability to predict a number of unused transmission opportunities that exceeds a configured size of UTO-UCI bitmap, resulting in increased signaling overhead and/or resource waste as described below. Another source or resource waste includes a PUSCH-based UTO reporting mechanism that may add delay to the UE transmitting UTO-UCI, resulting in the network node being unable to reallocate the unused transmission opportunity. Delayed transmission of UTO-UCI, increased signaling overhead, and/or increased resource waste may result in reduced data throughput and/or increased data transfer delays in a wireless network.

Various aspects relate generally to UE-selected resource skipping configuration. Some aspects more specifically relate to a UE selecting a resource skipping configuration that increases a resource usage efficiency in a wireless network. In some aspects, a UE may receive a first indication of one or more resource allocations that are assigned to the UE. As one example, the UE may receive an indication of one or more CG uplink allocations that are assigned to the UE and/or one or more dynamic grants that are assigned to the UE (e.g., a dynamic downlink allocation and/or a dynamic uplink allocation). Based at least in part on receiving the first indication of the resource allocation(s) that are assigned to the UE, the UE may transmit a second indication of a UE-selected resource skipping configuration that is based at least in part on the one or more resource allocations. Some examples of information that may be indicated in the UE-selected resource skipping configuration may include one or more of a selected resource allocation (e.g., from the one or more resource allocations) and an enabled resource skipping state for the selected resource allocation, an uplink channel for communicating a UTO indication (e.g., a PUSCH or a physical uplink control channel (PUCCH)), a UTO overlap state, a UTO indication communication type, a UTO indication resource unit type, or a UTO indication component carrier mode as described below.

Particular aspects of the subject matter described in this disclosure can be implemented to realize one or more of the following potential advantages. In some examples, by transmitting a UE-selected resource skipping configuration, the described techniques can be used to increase a resource usage efficiency that results in increased data throughput and/or decreased data transfer delays in a wireless network. To illustrate, the UE may select the UE-selected resource skipping configuration using information available to the UE (and not a network node), resulting in a UTO configuration that results in the UE using fewer air interface resources, reduces a delay in the UE providing a UTO indication to a network node, and/or increases reallocations performed by the network node. For instance, the network node may update a UTO configuration by updating a sliding window size and/or enabling and/or disabling UTO operations for a particular resource allocation using information indicated in the UE-selected resource skipping configuration, and the updated UTO configuration may result in increased resource usage efficiency, increased data throughput, and/or decreased data transfer delays in a wireless network.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

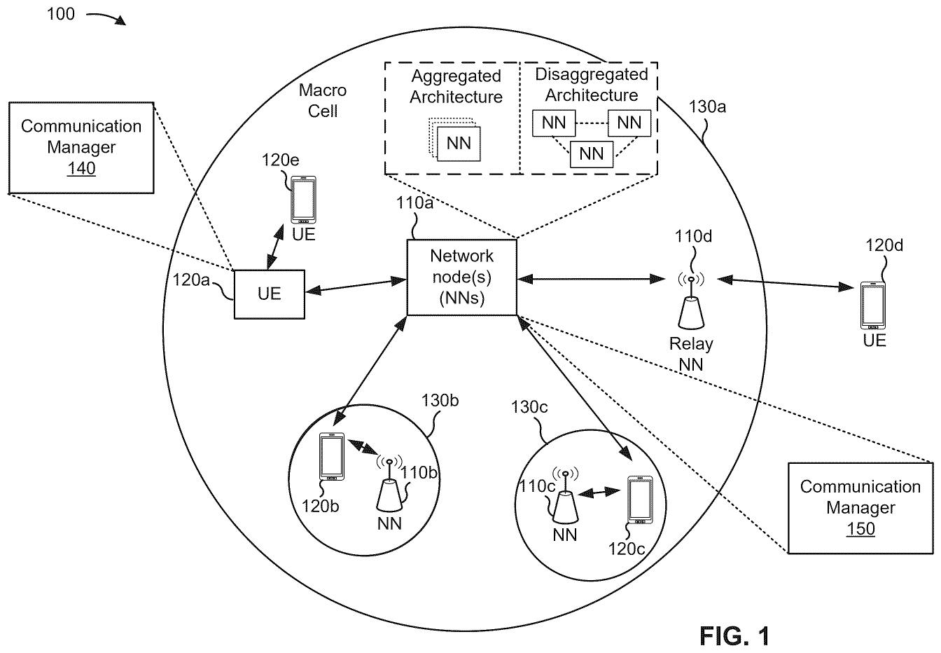

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V21) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may receive a first indication of one or more resource allocations that are assigned to the UE; and transmit a second indication of a UE-selected resource skipping configuration that is based at least in part on the one or more resource allocations. Additionally, or alternatively, the communication manager 140 may perform one or more other operations described herein.

In some aspects, a network node (e.g., a network node 110) may include a communication manager 150. As described in more detail elsewhere herein, the communication manager 150 may transmit a first indication of one or more resource allocations that are assigned to a UE; and receive a second indication of a UE-selected resource skipping configuration that is based at least in part on the one or more resource allocations. Additionally, or alternatively, the communication manager 150 may perform one or more other operations described herein.

As indicated above, FIG. 1 is provided as an example. Other examples may differ from what is described with regard to FIG. 1.

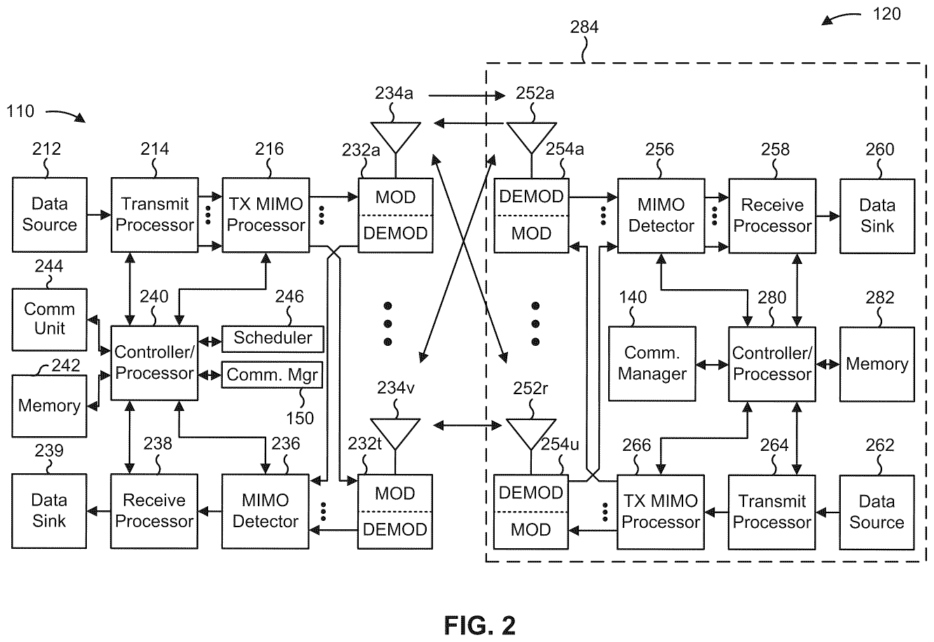

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

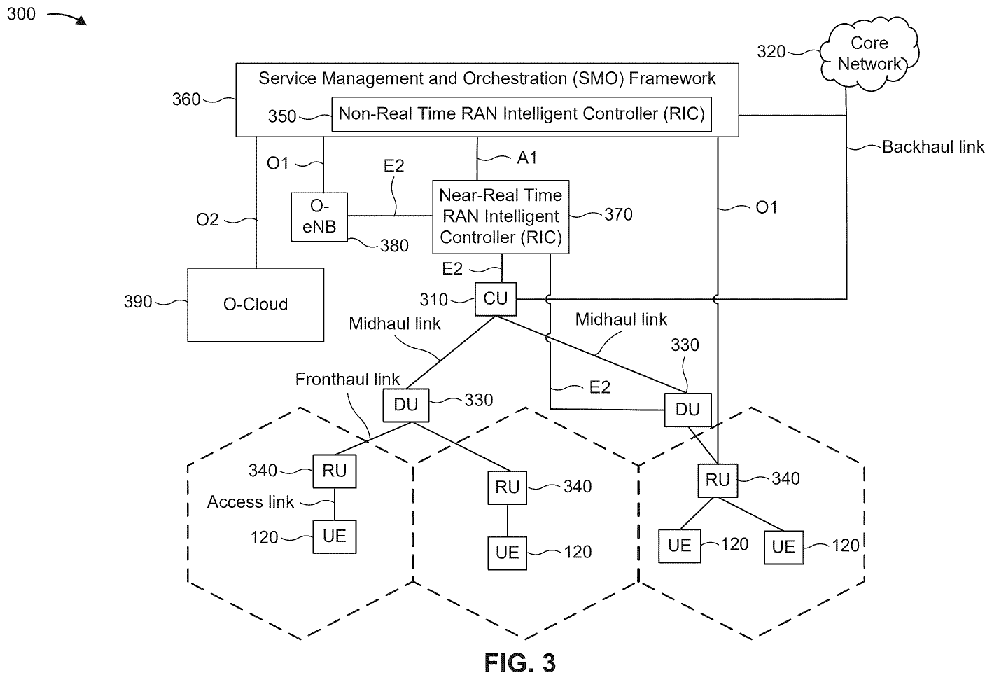

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

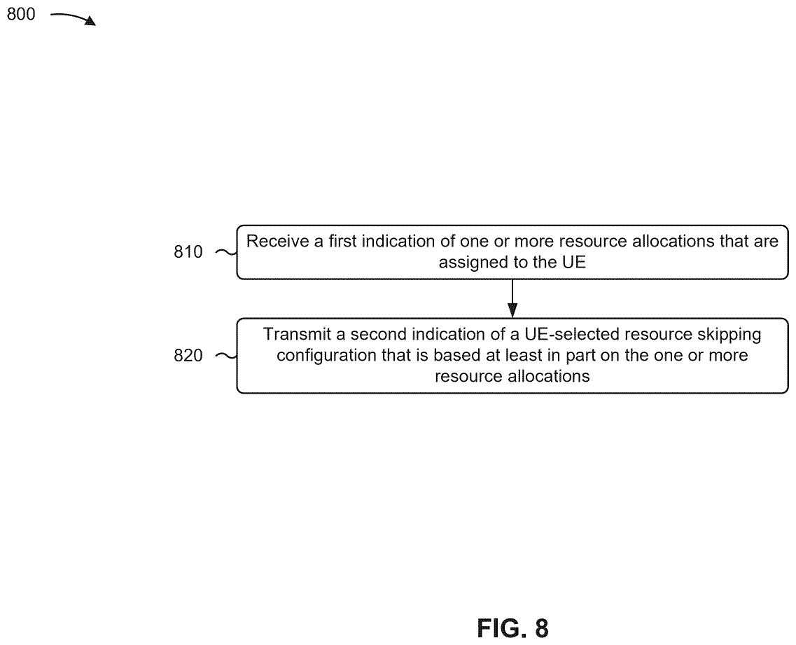

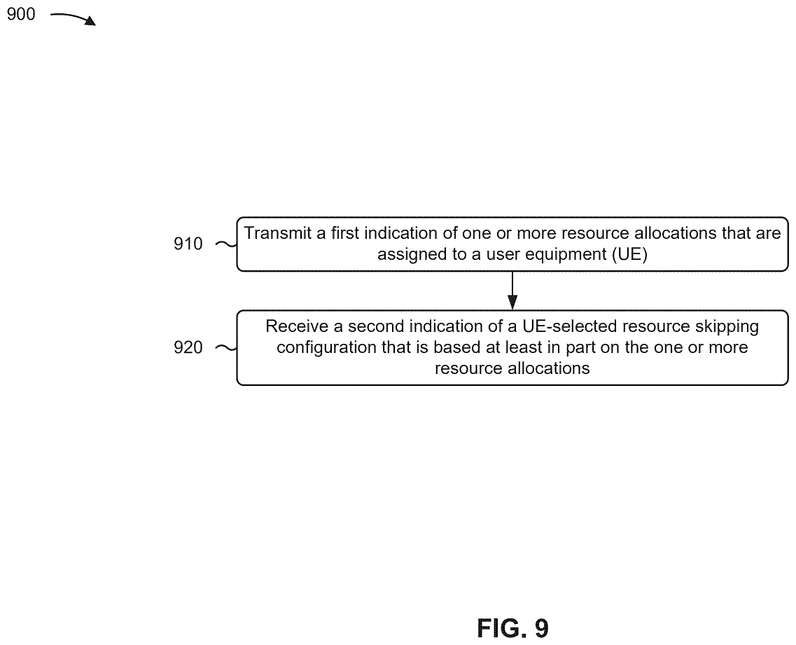

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a UE-selected resource skipping configuration, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE (e.g., a UE 120) includes means for receiving a first indication of one or more resource allocations that are assigned to the UE; and/or means for transmitting a second indication of a UE-selected resource skipping configuration that is based at least in part on the one or more resource allocations. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for transmitting a first indication of one or more resource allocations that are assigned to a UE; and/or means for receiving a second indication of a UE-selected resource skipping configuration that is based at least in part on the one or more resource allocations. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

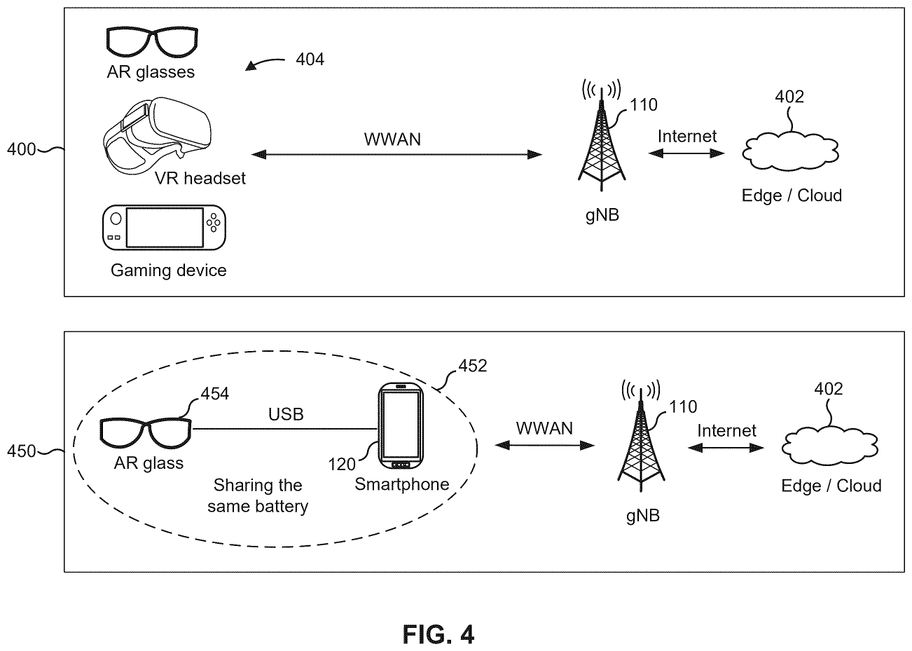

FIG. 4 is a diagram illustrating a first example 400 and a second example 450 of one or more UEs that are implemented in the form of an XR device, in accordance with the present disclosure.

The first example 400 includes a network node 110 that is connected to an edge computing device and/or edge cloud services (e.g., provided by one or more computing devices) as shown by reference number 402. In the example 400, the network node 110 communicates with the edge computing device and/or the edge cloud services via an Internet connection. As shown by reference number 404, the network node 110 may communicate with one or more UEs using a wireless wide area network (WWAN), such as a cellular network (e.g., a 5G network and/or a 6G network). In the first example 400, the UEs shown by reference number 404 include XR devices in the form of a wearable augmented reality (AR) device (e.g., AR glasses), a wearable virtual reality (VR) device (e.g., a VR headset), and a gaming device. Other examples may include a mixed reality (MR) device. In some aspects, the network node 110 acts as an intermediary device between the XR devices and the edge cloud services using the WWAN connection and the Internet connection. XR devices may have limited battery capacity while being expected to have a battery life of a smartphone (e.g., full day of use). Battery power is an issue even when the XR device is tethered to a smartphone and uses the same smartphone battery. XR device power dissipation may be limited and may lead to an uncomfortable user experience and/or a short battery life.

The second example 450 includes the network node 110 and the edge computing device and/or edge cloud services described with regard to the first example 400. As shown by reference number 452, a UE 120 may connect to an XR device 454 (shown as AR glasses) using a wired connection, such as a universal serial bus (USB) connection such that the UE 120 and the XR device 454 share a same battery. For example, a battery at the UE 120 may provide power to the XR device 454. The network node 110 may connect indirectly to the XR device 454 by connecting to the UE 120 using a WWAN connection, and the UE 120 may communicate and/or forward information from the network node 110 to the XR device 454 using the wired connection.

An XR device may include a UE 120 or may be associated with a UE 120. Multimedia traffic applications for an XR device (or for another type of gaming device such as a UE 120) may include a video game (e.g., where multimedia traffic is transferred to and from an edge server or a cloud environment at a particular frame rate to support audio and/or video rendering) and/or a VR environment (e.g., where multimedia traffic is transferred to and from an edge server or a cloud environment at a particular polling rate to support sensor (e.g., 6 degrees of freedom (6DOF) sensor input and feedback)), among other examples.

Seamless operation at an XR device and/or a gaming, device may have low-latency traffic and/or high-reliability conditions for data traffic to and from an edge server or a cloud environment. Alternatively, or additionally, the traffic to and from the edge server or the cloud environment may be periodic to support a particular frame rate (e.g., 120 frames per second (FPS), 90 FPS, 60 FPS) and/or a particular refresh rate (e.g., 500 Hertz (Hz), 120 (Hz)) for multimedia traffic applications such as XR and/or gaming. One example of a low-latency condition and/or a high-reliability condition is a condition that 99% of data traffic is delivered within a packet delay budget (PDB) of 10 milliseconds (msec).

As indicated above, FIG. 4 is provided as an example. Other examples may differ from what is described with regard to FIG. 4.

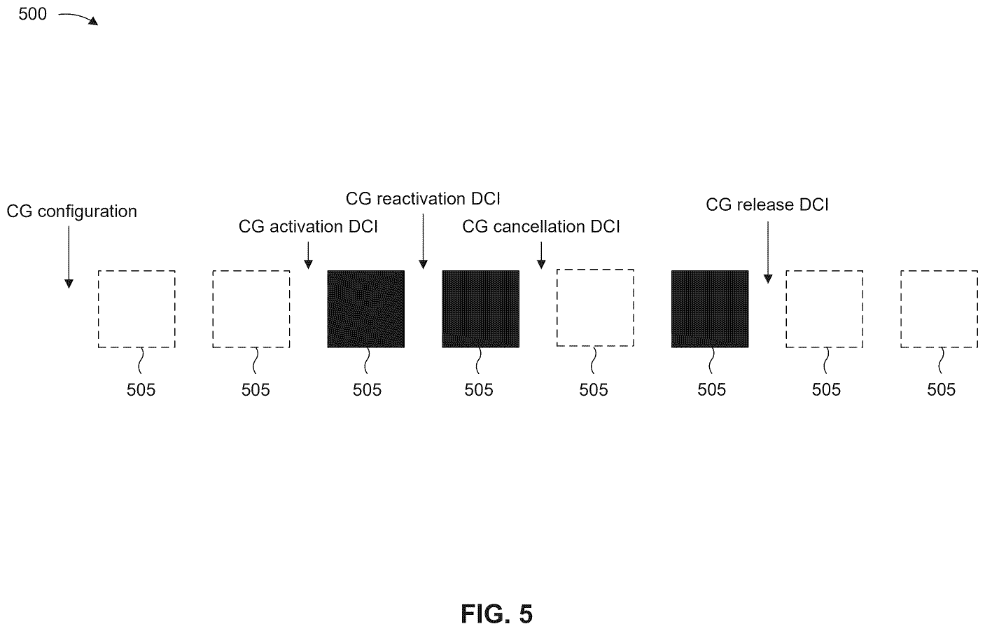

FIG. 5 is a diagram illustrating an example 500 of uplink CG communication, in accordance with the present disclosure. CG communications may include periodic uplink communications that are configured for a UE 120, such that a network node 110 does not need to send separate DCI to schedule each uplink communication, thereby conserving signaling overhead. Additionally, or alternatively, configuring periodic uplink resources for the UE 120 may avoid dynamic resource requests from the UE 120 based on a scheduling request (SR) and/or buffer status report (BSR) and corresponding resource assignment by the network node 110. Accordingly, CG communications may be useful for low-latency periodic traffic, such as XR uplink video.

As shown in example 500, a UE 120 may be configured with a CG configuration for CG communications. For example, the UE 120 may receive the CG configuration via an RRC message transmitted by a network node 110. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 505 for the UE 120. In some examples, the CG configuration may identify a resource pool or multiple resource pools that are available to the UE 120 for an uplink transmission. The CG configuration may configure contention-free CG communications (e.g., where resources are dedicated for the UE 120 to transmit uplink communications) or contention-based CG communications (e.g., where the UE 120 contends for access to a channel in the configured resource allocation, such as by using a channel access procedure or a channel sensing procedure).

The network node 110 may transmit CG activation DCI to the UE 120 to activate the CG configuration for the UE 120. The network node 110 may indicate, in the CG activation DCI, communication parameters, such as an MCS, a resource block (RB) allocation, and/or antenna ports, for the CG-PUSCH communications to be transmitted in the scheduled CG occasions 505. The UE 120 may begin transmitting in the CG occasions 505 based at least in part on receiving the CG activation DCI. For example, beginning with a next scheduled CG occasion 505 subsequent to receiving the CG activation DCI, the UE 120 may transmit a CG-PUSCH communication in the scheduled CG occasions 505 using the communication parameters indicated in the CG activation DCI. The UE 120 may refrain from transmitting in CG occasions 505 prior to receiving the CG activation DCI.

The network node 110 may transmit CG reactivation DCI to the UE 120 to change the communication parameters for the CG-PUSCH communications. Based at least in part on receiving the CG reactivation DCI, and the UE 120 may begin transmitting in the scheduled CG occasions 505 using the communication parameters indicated in the CG reactivation DCI. For example, beginning with a next scheduled CG occasion 505 subsequent to receiving the CG reactivation DCI, the UE 120 may transmit CG-PUSCH communications in the scheduled CG occasions 505 based at least in part on the communication parameters indicated in the CG reactivation DCI.

In some cases, such as when the network node 110 needs to override a scheduled CG-PUSCH communication for a higher priority communication, the network node 110 may transmit CG cancellation DCI to the UE 120 to temporarily cancel or deactivate one or more subsequent CG occasions 505 for the UE 120. The CG cancellation DCI may deactivate only a subsequent one CG occasion 505 or a subsequent N CG occasions 505 (where N is an integer). CG occasions 505 after the one or more (e.g., N) CG occasions 505 subsequent to the CG cancellation DCI may remain activated. Based at least in part on receiving the CG cancellation DCI, the UE 120 may refrain from transmitting in the one or more (e.g., N) CG occasions 505 subsequent to receiving the CG cancellation DCI. As shown in example 500, the CG cancellation DCI cancels one subsequent CG occasion 505 for the UE 120. After the CG occasion 505 (or N CG occasions) subsequent to receiving the CG cancellation DCI, the UE 120 may automatically resume transmission in the scheduled CG occasions 505.

The network node 110 may transmit CG release DCI to the UE 120 to deactivate the CG configuration for the UE 120. The UE 120 may stop transmitting in the scheduled CG occasions 505 based at least in part on receiving the CG release DCI. For example, the UE 120 may refrain from transmitting in any scheduled CG occasions 505 until another CG activation DCI is received from the network node 110. Whereas the CG cancellation DCI may deactivate only a subsequent one CG occasion 505 or a subsequent N CG occasions 505, the CG release DCI deactivates all subsequent CG occasions 505 for a given CG configuration for the UE 120 until the given CG configuration is activated again by a new CG activation DCI.

As indicated above, FIG. 5 is provided as an example. Other examples may differ from what is described with respect to FIG. 5.

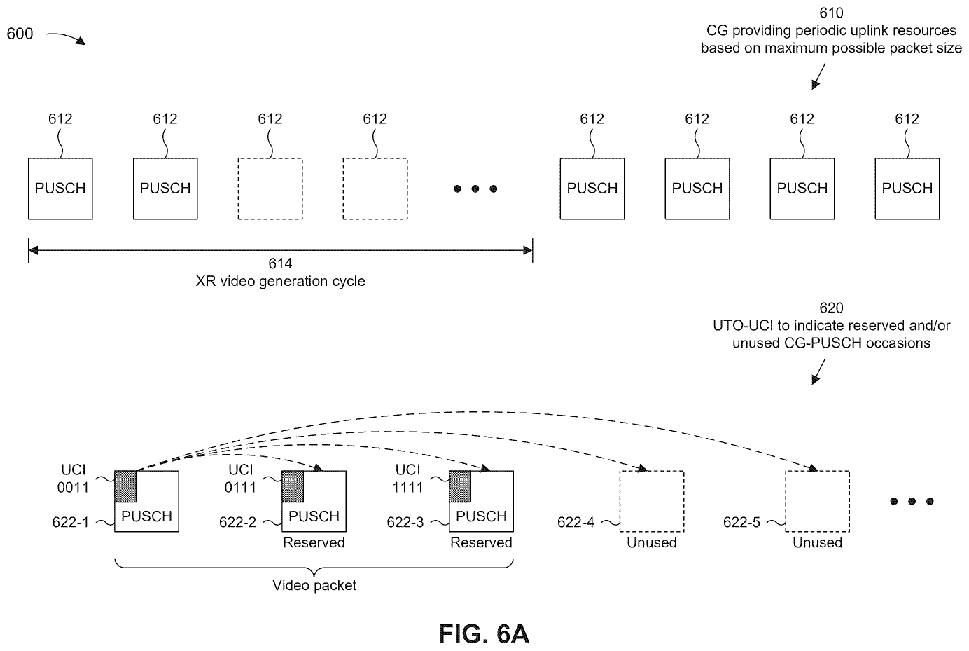

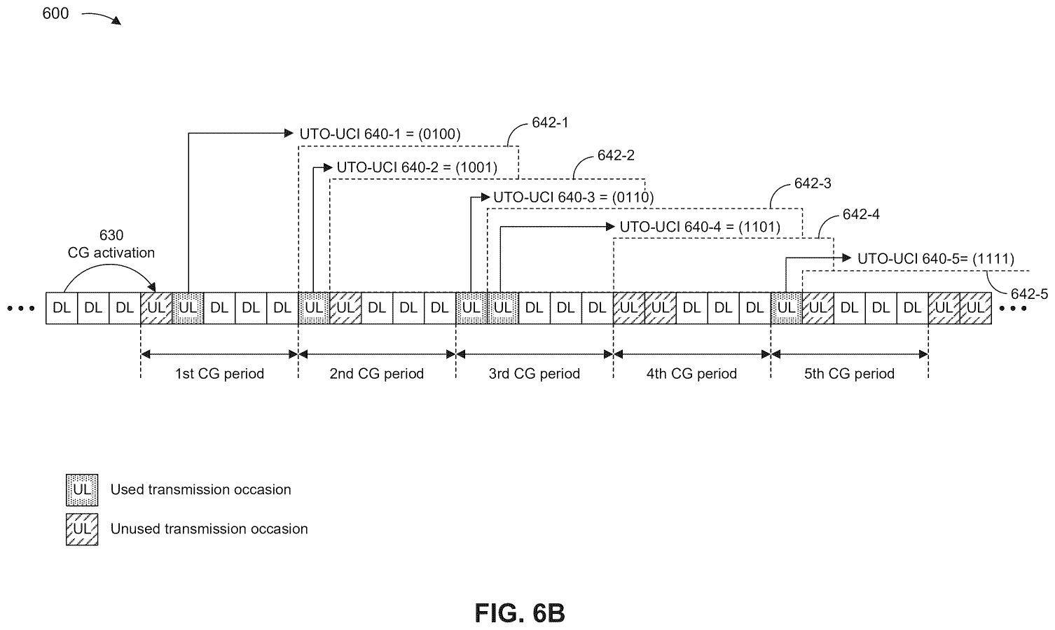

FIGS. 6A-6B are diagrams illustrating examples 600 of UTO-UCI for indicating unused uplink CG-PUSCH occasions, in accordance with the present disclosure. As described herein, a CG generally provides a UE 120 with periodic uplink resources such that a network node does not need to send separate DCI to schedule each uplink communication, thereby conserving signaling overhead. Furthermore, a CG avoids SR-based and/or BSR-based dynamic resource requests from the UE 120 and corresponding resource assignment by the network node, which makes CG communications useful for low-latency or uplink-heavy traffic, such as XR traffic.

Certain uplink traffic types, such as voice, XR video, and/or XR control or pose data, may be transmitted in periodic CG-PUSCH occasions. For example, as shown FIG. 6A, and by reference number 610, a network node 110 may provide a UE 120 with a CG configuration (e.g., via an RRC message) that indicates an uplink resource allocation (e.g., time domain resources, frequency domain resources, spatial domain resources, and/or code domain resources) and a periodicity at which the uplink resource allocation is repeated, resulting in periodically recurring scheduled CG-PUSCH occasions 612 that the UE 120 can use to transmit uplink data. In some cases, the network node 110 may configure the CG-PUSCH occasions 612 to ensure that sufficient uplink resources are allocated to the UE 120 to support a maximum packet size associated with a particular application that uses the CG-PUSCH occasions 612 to transmit uplink data. For example, unlike voice and/or uplink control and/or pose data, which tend to follow regular traffic patterns and have relatively small packet sizes, XR uplink video may be associated with a video frame size that varies over time and/or quasi-periodic packet arrival times with application jitter (e.g., causing XR traffic arrival times to vary). In other words, video packet size tends to be large and random (e.g., with uplink video packets arriving in bursts, in the sense that many uplink video packets may arrive very closely in time, and then there may be an idle period before a next cycle starts and a next traffic burst arrives).

For example, reference number 614 in FIG. 6A corresponds to an example XR video generation cycle, where uplink video data that arrives in a burst is transmitted in two consecutive CG-PUSCH occasions 612 (shown with a solid line) that are then followed by several CG-PUSCH occasions 612 in which no data is transmitted (shown with a dotted line). As further shown, the XR video generation cycle may then be followed by another burst, where uplink video data that arrives in the second burst is transmitted in four consecutive CG-PUSCH occasions 612 (shown with a solid line). Accordingly, to support XR uplink video and/or other uplink traffic types associated with large and/or random packet sizes (e.g., based on a bursty traffic pattern that may include sudden increases and/or decreases in traffic volumes and/or inter-packet arrival times), the network node 110 may provide the UE 120 with a CG resource allocation that includes sufficient uplink resources to accommodate the largest possible uplink packet size. In this way, the uplink resources provided by the periodic CG-PUSCH occasions 612 may minimize delay or latency associated with the uplink data. However, because the uplink resources are allocated to accommodate the largest possible uplink packet size, the CG resource allocation provided to the UE 120 may be resource-inefficient due to the statistical over-budgeting of the uplink resources. For example, as shown by reference number 614 in FIG. 6A, the uplink resources that are preconfigured within an XR video generation cycle may exceed the average video packet size, which can lead to wasted uplink resources. That is, the uplink resources associated with the unused CG-PUSCH occasions 612 shown with dotted lines could have been allocated to other UEs 120.

Accordingly, as shown by reference number 620, a wireless network may support UTO-UCI to allow a UE 120 to indicate one or more unused CG-PUSCH occasions and thereby avoid or mitigate wasted uplink resources. For example, as shown in FIG. 6A, a UE 120 may include UTO-UCI in each CG-PUSCH that the UE 120 transmits in a CG-PUSCH occasion 622, where the UTO-UCI may indicate, for one or more future CG-PUSCH occasions 622, whether the UE 120 is reserving the uplink resources associated with the one or more future CG-PUSCH occasions 622 or skipping the one or more future CG-PUSCH occasions 622 such that the uplink resources can be released and/or reallocated to other UEs 120. In some aspects, the UTO-UCI carried in a CG-PUSCH may contain a bitmap in which each bit indicates whether a future CG-PUSCH occasion 622 is unused or reserved. For example, the UTO-UCI is a bitmap that includes N bits to indicate whether N future CG-PUSCH occasion are unused or reserved, where N is in a range from 3 and 8, and where a value of one indicates that a future CG-PUSCH occasion 622 is unused (e.g., will be skipped) and a zero indicates that the future CG-PUSCH occasion 622 is reserved. For example, in FIG. 6A, the UTO-UCI transmitted with the CG-PUSCH in the first CG-PUSCH occasion 622-1 includes a “0011” to indicate that the next two CG-PUSCH occasions 622-2 and 622-3 are reserved, and that the following two CG-PUSCH occasions 622-4 and 622-5 will be unused. Furthermore, the UTO-UCI transmitted with the CG-PUSCH in the next CG-PUSCH occasion 622-2 includes a “0111” to indicate that the next CG-PUSCH occasion 622-3 is reserved, that future CG-PUSCH occasion 622-4 will be unused, that future CG-PUSCH occasion 622-5 will be unused, and that a subsequent CG-PUSCH occasion (not shown in FIG. 6A) will be unused. Similarly, the UTO-UCI transmitted with the CG-PUSCH in CG-PUSCH occasion 622-3 includes a “1111” to indicate that the next four CG-PUSCH occasions, starting with CG-PUSCH occasion 622-4, will be unused (e.g., skipped).

The example 600 continues to FIG. 6B. As shown by FIG. 6B, UTO-UCI may include a bitmap with Nu bits (Nu being an integer) to indicate whether the next Nu valid CG-PUSCH occasions in a sliding window will be used or unused. For example, Nu may have a value in a range from 3 to 8, where the value may be configured by RRC signaling. In some aspects, the value of Nu may be set to a minimum of 3 bits to avoid puncturing-based multiplexing of the UTO-UCI in a CG-PUSCH transmission. In general, when the UE 120 transmits a CG-PUSCH in a current CG-PUSCH occasion, the transmitted CG-PUSCH carries UTO-UCI that applies to the Nu consecutive and valid CG-PUSCH occasions that follow the current CG-PUSCH occasion, starting at an offset from the end of the transmitted CG-PUSCH. For instance, FIG. 6B illustrates an example timeline that includes four CG periods: a first (1st) CG period, a second (2nd) CG period, a third (3rd) CG period, a fourth (4th) CG period, and a fifth (5th) CG period. Each CG period includes two CG-PUSCH occasions (shown by FIG. 6B as uplink (UL) occasions) and three downlink (DL) transmission time intervals (TTIs). In the example shown in FIG. 6B, the UE 120 receives a CG activation message 630 from the network node, skips the first CG-PUSCH occasion in the first CG period (shown with diagonal stripes), and then transmits a CG-PUSCH in the second CG-PUSCH occasion in the 1st CG period (shown with a dotted pattern).

The CG-PUSCH transmitted in the second CG-PUSCH occasion of the 1st CG period includes UTO-UCI 640-1 that carries a bitmap that includes four bits (e.g., Nu=4) and is set to a value of “0100” to indicate that the UE 120 intends to [not skip/skip/not skip/not skip] the next four CG-PUSCH occasions. In some aspects, the bitmap included in the UTO-UCI 640-1 pertains to a first reporting window 642-1 that starts at a next CG-PUSCH occasion (e.g., the first CG-PUSCH occasion in the 2nd CG period) and has a duration that is based at least in part on the occurrence of four CG-PUSCH occasions.

As shown by FIG. 6B, the UE 120 proceeds by transmitting a CG-PUSCH in the next CG-PUSCH occasion that corresponds to the first CG-PUSCH occasion of the 2nd CG period, and the CG-PUSCH includes UTO-UCI 640-2 that carries a bitmap of “1001” to indicate that the UE 120 intends to [skip/not skip/not skip/skip] the next four CG-PUSCH occasions. In some aspects, the bitmap included in the UTO-UCI 640-2 pertains to a second reporting window 642-2 that starts at a next CG-PUSCH occasion (e.g., the second CG-PUSCH occasion in the 2nd CG period) and has a duration that is based at least in part on the occurrence of four CG-PUSCH occasions.

The UE 120 may then transmit a CG-PUSCH in the first CG-PUSCH occasion of the third CG period, and the CG-PUSCH may include UTO-UCI 640-3 that carries a bitmap of “0110” to indicate that the UE 120 intends to [not skip/skip/skip/not skip] the next four CG-PUSCH occasions. In some aspects, the bitmap included in the UTO-UCI 640-3 pertains to a third reporting window 642-3 that starts at a next CG-PUSCH occasion (e.g., the second CG-PUSCH occasion in the 3rd CG period) and has a duration that is based at least in part on the occurrence of four CG-PUSCH occasions.

The UE 120 next transmits a CG-PUSCH in the second CG-PUSCH occasion of the 3rd CG period, which includes UTO-UCI 640-4 that carries a bitmap of “1101” to indicate that the UE 120 intends to [skip/skip/not skip/skip] the next four CG-PUSCH occasions. In some aspects, the bitmap included in the UTO-UCI 640-4 pertains to a fourth reporting window 642-4 that starts at a next CG-PUSCH occasion (e.g., the first CG-PUSCH occasion in the 4th CG period) and has a duration that is based at least in part on the occurrence of four CG-PUSCH occasions.

As shown by FIG. 6B, the UE 120 next transmits a CG-PUSCH in the first CG-PUSCH occasion of the 5th CG period (after skipping both CG-PUSCH occasions in the fourth CG period), and the CG-PUSCH transmitted in the first CG-PUSCH occasion of the 5th CG period includes UTO-UCI 640-5 that carries a bitmap of “1111” to indicate that the UE 120 intends to skip the next four CG-PUSCH occasions. In some aspects, the bitmap included in the UTO-UCI 640-5 pertains to a fifth reporting window 642-5 that starts at a next CG-PUSCH occasion (e.g., the second CG-PUSCH occasion in the 5th CG period) and has a duration that is based at least in part on the occurrence of four CG-PUSCH occasions. Collectively, the first reporting window 642-1, the second reporting window 642-2, the third reporting window 642-3, the fourth reporting window 642-4, and the fifth reporting window 642-5 may be referred to as a sliding window, where the sliding window has a changing start time and is based at least in part on a same number of resources. To illustrate, the duration of the sliding window may be based at least in part on four valid transmission occasions, and the time span between a first valid transmission occasion and the fourth valid transmission occasion may change for different start times.

Through the use of UTO-UCI, a UE 120 may indicate future uplink resources of a resource allocation (e.g., one or more CG-PUSCH occasions) that the UE 120 intents to skip and/or not use. Based at least in part on receiving the UTO-UCI, a network node 110 may identify the future CG-PUSCH occasions that the UE 120 intends to skip, and may reallocate the uplink resources associated with the unused CG-PUSCH occasions. In one example, and as shown by FIG. 6B, the UE 120 may indicate unused and/or skipped future uplink resources by setting a particular bit of a bitmap to a first bit value (e.g., “0”) or a second bit value (e.g., “1”) to indicate, respectively, whether a particular transmission occasion will be used or unused by the UE 120 When the UE 120 indicates a value that indicates that the particular transmission occasion will be unused, the UE 120 may continue to indicate the value in subsequent UTO-UCI and does not use the particular transmission occasion.

As described above, a network node (e.g., a network node 110) may configure UTO-UCI operation at a UE (e.g., a UE 120), such as by transmitting one or more configuration parameters via RRC signaling. To illustrate, the network node may configure a number of bits that are used by a bitmap (e.g., Nu) that indicate whether the next Nu valid CG-PUSCH occasions will be used or skipped and/or may configure whether a particular CG assigned to the UE includes UTO operation. For enabled UTO operation, the UE may multiplex UTO-UCI and/or the bitmap in a CG-PUSCH transmission. Each bit of the UTO-UCI bitmap may have a one-to-one mapping with a subsequent transmission occasion (e.g., a CG-PUSCH transmission occasion), and, in some aspects, the one-to-one mapping may be based at least in part on an ascending order of a start time of a sliding window and/or a transmission occasion that occurs first in time. To illustrate, a first bit of the bitmap (e.g., either a most significant bit (MSB) or a least significant bit (LSB)) may map to a first transmission occasion that occurs first in time after the bitmap transmission, a second bit of the bitmap may map to a second transmission occasion that occurs second in time after the bitmap transmission, and a third bit of the bitmap may map to a third transmission occasion that occurs third in time after the bitmap transmission.

For unpaired spectrum operation (e.g., time division duplexing (TDD) in which uplink transmissions and downlink transmissions share a same frequency band at different times), the mapping of bits may exclude invalid transmission occasions, such as a transmission occasion that is not used by the UE, such as a transmission occasion that is used for a downlink transmission. For instance, and as shown by FIG. 6B, the sliding window and/or the bitmap may be based at least in part on uplink transmission occasions (e.g., CG transmission occasions) assigned to the UE and not downlink transmission occasions that occur in between the uplink transmission occasions.

A network node configuring UTO operation at a UE may lead to inefficiencies (e.g., resource waste and/or air interface resources that are unused by the UE and are not reallocated by the network node), where “UTO operation” may denote enabling, configuring, and/or using UTO-UCI communications. To illustrate, the UE may have information that is unavailable to the network node (e.g., information that is local to the UE), such as an uplink data traffic profile that may be characterized by a data packet size, a data packet frequency, and/or number of data packets. Alternatively, or additionally, the UE may use a local data packet mapping algorithm that increases data throughput and/or decreases data transfer delay by selecting an efficient mapping of uplink data traffic packets to one or more transmission occasions of a CG. That is, the local data packet mapping algorithm may select an optimal transmission configuration that is based at least in part on pending uplink data packets and one or more available transmission occasions.

As another example, the UE may be assigned multiple CG configurations, such as a first CG configuration that includes transmission occasion allocations that are configured for small data packets (e.g., a data packet size and/or resource allocation size that satisfies a small threshold) and a second CG configuration that includes transmission occasion allocations that are configured for large data packets (e.g., a data packet size and/or resource allocation size that satisfies a large threshold). An example small data packet may include an XR pose data packet and/or an XR control data packet that includes 100 bytes, and an example large data packet may include a video data packet that includes 1200 bytes. Based at least in part on an uplink data traffic profile, the UE may be able select which CG configurations would benefit from having UTO operations enabled and/or which CG configurations would not benefit from having UTO operations enabled.

To illustrate, a first CG configuration of the multiple CG configurations may be used to carry UL pose data and/or XR control packets. In some aspects, the first CG configuration may include transmission occasion allocations that are configured for small data packets as described above. Based at least in part on a size of the UL pose data and/or XR control packets (e.g., approximately 100 bytes), the UE may not skip transmission opportunities of the first CG configuration. Although the UE may transmit UTO-UCI using the first CG configuration, the UE may not utilize a UTO skipping feature such that the UE uses each transmission opportunity to transmit respective XR pose data and/or a respective XR control packet. As another example, the rate and/or regularity of transmission opportunities in the first CG configuration may be mismatched with the rate and/or regularity of the XR pose data and/or XR control data. Based at least in part on the regularity mismatch, the UE may bundle uplink data packets together, resulting in multiple uplink data packets being transmitted in a same transmission opportunity. Consequently, the UE may use the UTO skipping feature for some transmission opportunities. Accordingly, different uplink data traffic profiles may affect the efficiency of the first CG configuration.

Another example of UE-local information includes a scenario in which the UE includes a data packet bundling priority. To illustrate, the UE may include a packet bundling algorithm that is unknown to the network node, and the packet bundling algorithm may prioritize bundling data packets together higher than not bundling data packets together. Based at least in part on the prioritization, the UE may bundle multiple data packets together, such as XR pose data packets, based at least in part on determining that a resource allocation size of a transmission occasion is large enough to accommodate the bundled data packets. Thus, and unknown to the network node, the packet bundling algorithm at the UE may affect whether using a UTO skipping feature would reduce resource waste or not. That is, the packet bundling algorithm may affect whether a CG configuration having an enabled UTO operation would increase or decrease the efficiency of resource usage.

The transmission of UTO-UCI via a CG transmission opportunity (e.g., a CG-PUSCH transmission opportunity) may add delay to the transmission of UTO-UCI and may also lead to resource waste. To illustrate, and with regard to FIG. 6B, the UE may determine to skip the first UL transmission occasion and/or the second UL transmission occasions in the 2nd CG period (e.g., CG-PUSCH transmission occasions). However, the UE may make the determination to skip the first and second UL transmission occasions after the second UL transmission occasion in the 1st CG period. Accordingly, the UE may delay transmitting the UTO-UCI until the first UL transmission occasion in the 2nd CG period (e.g., the next CG-PUSCH transmission opportunity), and the delay may result in the network node being unable to reallocate the (unused) transmission occasion, such as an unused transmission occasion that occurs first in time relative to receipt of the UTO-UCI (e.g., the second UL transmission occasion in the 2nd CG period) and/or a transmission occasion that the UE uses to carry the UTO-UCI (e.g., the first UL transmission occasion in the 2nd CG period). That is, the delay may result in the network node not having enough time to reallocate the unused transmission occasion.

A size of a sliding window (e.g., a reporting window size) may also lead to resource waste. To illustrate, and as described above, the size of UTO-UCI bitmap (and a sliding window) may be configured by a network node (e.g., RRC configured). In one example, the network node may configure the UTO-UCI bitmap with a size of x (x being an integer), resulting in the UE being able to indicate up to x unused and/or skipped transmission opportunities in the UTO-UCI. As described above, each bit of the bitmap may map to a respective CG transmission opportunity that, combined, enable the UE to indicate a skipped status (e.g., skipped or use) for the next x CG transmission opportunities. In some aspects, the UE may predict and/or determine that y transmission opportunities may be unused and/or skipped, where y is an integer that is greater than x (e.g., y>x). However, the UE cannot indicate the y unused and/or skipped transmission opportunities using a single bitmap with x bits, which may result in inefficient UTO reporting that increases a reporting delay by the UE and/or increases a signaling overhead by the UE. Accordingly, without the use of UE-local information and/or alternate reporting channels, a network node configuring UTO operation at a UE may lead to increased reporting delay, increased the resource waste, and/or increased signaling overhead. The increased resource waste and/or increased signaling overhead may result in reduced data throughput and/or increased data transfer delays in a wireless network.

Various aspects relate generally to a UE-selected resource skipping configuration. Some aspects more specifically relate to a UE selecting a resource skipping configuration that increases a resource usage efficiency in a wireless network. In some aspects, a UE may receive a first indication of one or more resource allocations that are assigned to the UE. As one example, the UE may receive an indication of one or more CG uplink allocations that are assigned to the UE and/or one or more dynamic grants that are assigned to the UE (e.g., a dynamic downlink allocation and/or a dynamic uplink allocation). Based at least in part on receiving the first indication of the resource allocation(s) that are assigned to the UE, the UE may transmit a second indication of a UE-selected resource skipping configuration that is based at least in part on the one or more resource allocations. Some examples of information that may be indicated in the UE-selected resource skipping configuration may include one or more of a selected resource allocation (e.g., from the one or more resource allocations) and an enabled resource skipping state for the selected resource allocation, an uplink channel for communicating a UTO indication (e.g., a PUSCH or a PUCCH), a UTO overlap state, a UTO indication communication type, a UTO indication resource unit type, or a UTO indication component carrier mode as described below.

Particular aspects of the subject matter described in this disclosure can be implemented to realize one or more of the following potential advantages. In some examples, by transmitting a UE-selected resource skipping configuration, the described techniques can be used to increase a resource usage efficiency that results in increased data throughput and/or decreased data transfer delays in a wireless network. To illustrate, the UE may select the UE-selected resource skipping configuration using information available to the UE (and not a network node), resulting in a UTO configuration that results in the UE using fewer air interface resources, reduces a delay in the UE providing a UTO indication to a network node, and/or increases reallocations performed by the network node. For instance, the network node may update a UTO configuration by updating a sliding window size and/or enabling and/or disabling UTO operations for a particular resource allocation using information indicated in the UE-selected resource skipping configuration, and the updated UTO configuration may result in increased resource usage efficiency, increased data throughput, and/or decreased data transfer delays in a wireless network.

As indicated above, FIGS. 6A-6B are provided as examples. Other examples may differ from what is described with respect to FIGS. 6A-6B.

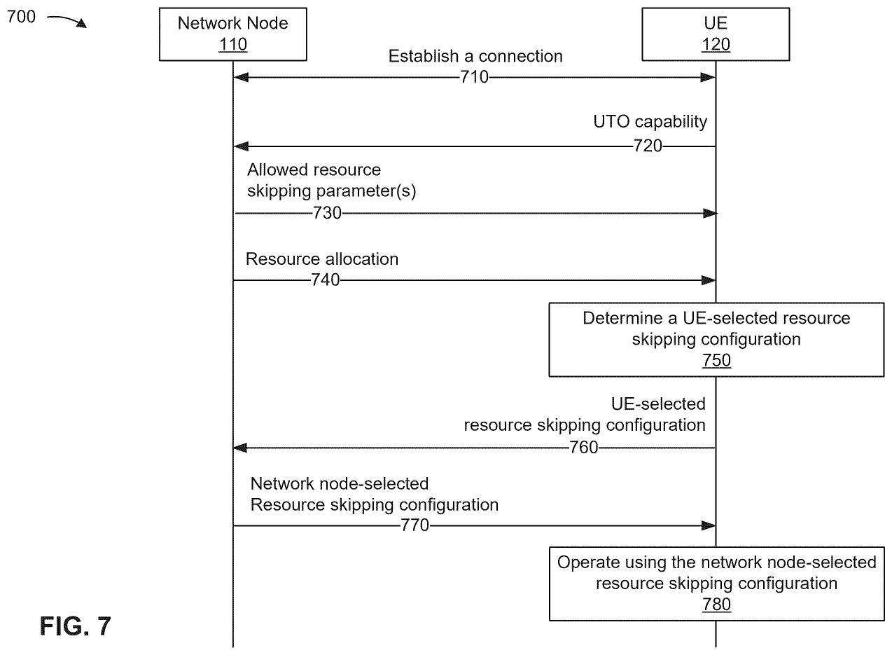

FIG. 7 is a diagram illustrating an example 700 of a wireless communication process between a network node (e.g., the network node 110) and a UE (e.g., the UE 120), in accordance with the present disclosure.

As shown by reference number 710, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE being tolerant of communication delays, and the network node 110 may transmit an activation of the configuration via Layer 2 signaling and/or Layer 1 signaling at a second point in time associated with the UE being intolerant to communication delays.

As shown by reference number 720, the UE 120 may transmit, and the network node 110 may receive, an indication of a UTO capability, where a UTO may indicate one or more capabilities supported by the UE 120 for configuring resource skipping. For clarity, FIG. 7 illustrates the UE 120 transmitting the indication of the UTO capability as a separate signaling transaction from establishing a connection with the network node 110, but in some examples, the UE 120 may transmit the indication of the UTO capability as part of establishing the connection with the UE. To illustrate, the UE 120 may transmit the indication of the UTO capability in response to a capability enquiry from the network node 110 that is transmitted as part of establishing a connection.

As one example of a UTO capability, the UE 120 may transmit an indication that the UE 120 supports generating a UE-selected resource skipping configuration. Alternatively, or additionally, the UE 120 may indicate support for generating one or more specific parameters of a UE-selected resource skipping configuration. Indicating support for a specific parameter may implicitly and/or explicitly specify that the UE supports functionality linked to the parameter. For instance, the UE may indicate support for selecting a particular resource allocation (e.g., from one or more resource allocations) and selecting a resource skipping state (e.g., an enabled state and/or a disabled state) for UTO operations linked to the particular resource allocation. In some aspects, the UE 120 may indicate support for selecting an uplink channel to use for communicating a UTO indication (e.g., a preferred reporting channel for resource skipping). Examples of a preferred reporting channel may include a PUSCH and/or a PUCCH for transmitting UTO-UCI.

The UE 120 may indicate support for selecting and/or specifying a UTO overlap state, where a UTO overlap state may indicate whether a resource skipping indication (e.g., UTO-UCI) is applicable to overlapping transmission occasions (e.g., CG PUSCH occasions that are overlapping) or non-overlapping transmission occasions (e.g., only non-overlapping transmission occasions and not overlapping transmission occasions). In some aspects, the UE 120 may indicate support for specifying a UTO indication communication type, such as bitmap and/or a start and length indicator value (SLIV) that may be used to indicate an unused resource.

Alternatively, or additionally, the UE 120 may indicate support for specifying a UTO indication resource unit type. To illustrate, a UTO indication may indicate whether a resource unit is being used or skipped (e.g., a skipping state), and the resource unit may include a time resource, a frequency resource, a time and frequency resource, a transmission occasion, a symbol, a resource block, and/or a time slot. Accordingly, by indicating support for specifying a UTO indication resource unit type, the UE 120 may indicate that the UE 120 supported different types of resource units for resource skipping and/or configuring different UTO indications for different types of resource units. In some aspects, the UE 120 may indicate support for specifying a UTO indication component carrier mode, where a UTO indication component carrier mode indicates whether a resource skipping indication (e.g., a UTO indication and/or UTO-UCI) is applicable to multiple component carriers or a single component carrier. Alternatively, or additionally, the UE 120 may indicate support for configuring a duration for a UTO sliding window, a number of skipped resource units (e.g., a number of transmission opportunities in the UTO sliding window), and/or a bitmap size (e.g., Nu). As described above, the duration of UTO sliding window may be characterized using a number of valid resources (e.g., a number of transmission occasions).

As shown by reference number 730, the network node 110 may transmit, and the UE 120 may receive, an indication of one or more allowed resource skipping parameters. That is, the network node 110 may indicate one or more resource skipping parameters (e.g., associated with UTO operation by the UE) that the UE 120 is allowed to modify and/or to configure via a UE-selected resource skipping configuration. The network node 110 may transmit the indication of the allowed resource skipping parameter(s) in Layer 1 signaling (e.g., DCI), Layer 2 signaling (e.g., a MAC CE), and/or in Layer 3 signaling (e.g., RRC signaling). For instance, the network node 110 may transmit the indication of the allowed resource skipping parameter(s) by transmitting an information element (IE) in RRC signaling, and the IE may indicate the allowed resource skipping parameter(s). In some aspects, the network node 110 may transmit the indication of the allowed resource skipping parameter(s) based at least in part on receiving a UTO capability from the UE 120 that indicates the UE supports generating a UE-selected resource skipping configuration.

Examples of allowed resource skipping parameter(s) may include a minimum number of resource allocations (e.g., a minimum number of CG configurations), a maximum number of resource allocations (e.g., a maximum number of CG configurations), resource allocation identifiers of resource allocations (e.g., CG configurations), one or more allowed and/or disallowed UTO communication channels (e.g., whether UTO-UCI on PUCCH is allowed and/or disallowed and/or whether UTO-UCI on PUSCH is allowed and/or disallowed), a maximum sliding window size, a minimum sliding window size, and/or one or more allowed UTO indication communication types (e.g., whether a bitmap is allowed and/or disallowed and/or whether SLIV is allowed and/or disallowed). The inclusion of an allowed resource skipping parameter in the indication from the network node 110 may implicitly indicate that the UE 120 is allowed to configure the resource skipping parameter, and exclusion of an allowed resource skipping parameter in the indication from the network node 110 may implicitly indicate that the UE 120 is not allowed to configure the resource skipping parameter. That is, each resource skipping parameter may be optionally indicated by the network node 110. Alternatively, or additionally, the network node 110 may include an explicit indication, such as a respective enabled state and/or a disabled state, for each resource skipping parameter to indicate whether the resource skipping parameter is UE-configurable.

As shown by reference number 740, the network node 110 may transmit, and the UE 120 may receive, an indication of one or more resource allocations that are assigned to the UE 120. For instance, the network node may transmit an indication of one or more CG uplink allocations, one or more dynamic uplink allocations, and/or one or more downlink grant allocations that are assigned to the UE 120. In some aspects, as part of indicating a resource allocation, the network node 110 may indicate one or more network-node-selected resource skipping configurations that apply to one or more of the resource allocations, such as by indicating a network-node-selected resource skipping configuration for a resource allocation that has an enabled resource skipping state.

As shown by reference number 750, the UE 120 may determine a UE-selected resource skipping configuration, and the UE-selected resource skipping configuration may indicate one or resource skipping parameter configurations. In some aspects, the UE 120 may use any combination of an artificial intelligence (AI) algorithm, a machine learning (ML) algorithm, and/or a static algorithm to select a UE-selected resource skipping configuration. The AI algorithm, the ML algorithm, and/or the static algorithm may be configured to select a UE-selected resource skipping configuration that reduces resource waste in a wireless network using at least UE-local information. In some aspects, the UE-selected resource skipping configuration may indicate UE-preferred and/or UE-recommended resource skipping parameter configurations, and in other aspects, the UE-selected resource skipping configuration may indicate an updated resource skipping configuration the UE 120 will be using.

As one example, the UE 120 may select, as at least part of the UE-selected resource skipping configuration, a resource allocation (e.g., from the resource allocation(s) received from the network node 110) and/or a resource skipping state for the selected resource allocation. To illustrate, based at least in part on a data traffic profile, a bundling prioritization, a data packet mapping algorithm, and/or other UE-local information, the UE 120 may select an enabled resource skipping state for a first CG configuration and a disabled resource skipping state for a second CG configuration based at least in part on reducing resource waste as described above. As another example, the UE 120 may select an uplink channel for communicating a UTO indication (e.g., a PUCCH and/or a PUSCH) and/or a UTO overlap state (e.g., an overlapping state in which a resource skipping indication applies to overlapping transmission opportunities, or a non-overlapping state in which the resource skipping indication applies to non-overlapping transmissions). Other examples may include the UE 120 selecting a UTO indication communication type (e.g., a bitmap communication type and/or an SLIV communication type), a UTO indication resource unit type (e.g., a transmission occasion, a resource block, a symbol, and/or a time slot), and/or a UTO indication component carrier mode (e.g., multiple component carrier mode and/or a single component carrier mode). Alternatively or additionally, the UE 120 may select, as at least part of the UE selected resource skipping configuration, a duration for a UTO sliding window and/or a number of future resources (e.g., transmission occasions) that are specified in a UTO indication to reduce UE signaling overhead and/or increase resource reallocation. As described above, the duration of a UTO sliding window may be based at least in part on a number of resources, and a time span between a starting resource and an ending resource of the UTO sliding window may change based at least in part on a location of the starting resource and resource allocation pattern (e.g., a mixture of UL resources and DL resources in a CG period).

In some aspects, the UE-selected resource skipping configuration may be specific to a particular resource allocation (e.g., a particular CG configuration) and/or may be applicable to multiple resource allocations (e.g., multiple CG configurations). The UE 120 may select different UE-selected resource skipping configurations for different resource allocations. In some aspects, the UE 120 may transmit the UE selected resource skipping configuration in, or as, assistance information using any combination of Layer 1 signaling (e.g., UCI), Layer 2 signaling (e.g., a MAC CE), and/or RRC signaling.

Based at least in part on being able to indicate a resource skipping state for multiple resource allocations, the UE 120 may indicate an enabled resource skipping state for two or more resource allocations. In some aspects, the UE 120 may indicate a mapping of a respective UTO indication for each resource allocation with an enabled resource skipping state. Examples a UTO indication communication type include a bitmap and/or an SLIV, and a mapping may indicate an interlacing of the respective UTO indications. For instance, the mapping may indicate that the interlacing of the UTO indications may be based at least in part on an initial transmission occasion of the resource allocations and/or that a UTO indication associated with the resource allocation that includes the initial transmission occasion is mapped to be a starting UTO indication.

At times, the UE 120 may select, as at least part of a UE selected resource skipping configuration, an applicability duration of a UTO indication (e.g., an applicability duration of a UTO-UCI and/or a number of future transmission occasions). For instance, the applicability duration may specify a duration that a UTO indication is persistent (e.g., sticky). A long duration (e.g., that satisfies a long duration threshold) may trigger the network node 110 to reconfigure one or more of the resource allocations, such as by reconfiguring a number of transmission occasions in a CG and/or reconfiguring a resource allocation size of a transmission occasion, to reduce resource waste.

In some aspects, a resource allocation may be a downlink resource allocation (e.g., a downlink grant), and the UE 120 may determine a UE-selected resource skipping configuration for the downlink resource allocation. For instance, based at least in part on a buffer status report (BSR), the UE 120 may determine that the downlink resource allocation is overallocated to the UE 120. Accordingly, the UE 120 may generate a UE-selected resource skipping configuration that indicates the downlink resource allocation is overallocated and/or may be unused. Accordingly, the UE 120 may generate, and/or trigger the transmission of, a UE-selected resource skipping configuration based at least in part on a BSR.

The UE-selected resource skipping configuration selected by the UE 120 may be based at least in part on allowed resource skipping parameter(s) as described with regard to reference number 730. To illustrate, the UE 120 may select a configuration for an allowed resource skipping parameter that is indicated by the network node 110 and/or may not select a configuration for a disallowed resource skipping parameter.

As shown by reference number 760, the UE 120 may transmit, and the network node 110 may receive, an indication of the UE-selected resource skipping configuration, and the UE-selected resource skipping configuration may include any combination of information determined by the UE as described with regard to reference number 750. For instance, the UE-selected resource skipping configuration may indicate a configuration for any combination of a duration for a UTO sliding window, a resource allocation and a resource skipping state, an uplink channel (e.g., for communicating a UTO indication), a UTO overlap state, a UTO indication communication type, a UTO indication resource unit type, a UTO indication component carrier mode, a mapping of a respective UTO indication for multiple resource allocations with an enabled resource skipping state, and/or an applicability duration.

The UE 120 may transmit the indication of the UE-selected resource configuration in Layer 1 signaling (e.g., UCI), Layer 2 signaling (e.g., a MAC CE), and/or Layer 3 signaling (e.g., RRC signaling). In some aspects, the UE may transmit the indication of the UE-selected resource configuration in an uplink MAC CE. For instance, the MAC CE may include a bitmap, and each bit of the bitmap may be linked to a respective resource allocation assigned to the UE. The UE 120 may set each bit to a respective value (e.g., a “0” or a “1”) to indicate an enabled state and/or a disabled state for a particular resource allocation. To illustrate, a first bit in the bitmap may be linked and/or may map to a first CG configuration, and a second bit in the bitmap may be linked and/or may map to a second CG configuration. The UE 120 may set the first bit to a first value (e.g., “1”) to indicate that UTO operation (e.g., resource skipping) is disabled for the first CG configuration and/or the UE 120 may set the second bit to a second value (e.g., “0”) to indicate that UTO operation is enabled for the second CG configuration. In some aspects, the bits in the bitmap may be map to a respective resource allocation based at least in part on a resource allocation ID. For instance, each resource allocation may be a respective CG configuration that has a respective CG identifier (ID), and the bits may map to the respective CG configurations in ascending order (or descending order) of the CG IDs. For instance, a least significant bit (LSB) of the bitmap may map to a CG configuration with a lowest ID, and a most significant bit (MSB) of the bitmap may map to a CG configuration with a highest ID (or vice versa).

As shown by reference number 770, the network node 110 may transmit, and the UE 120 may receive, an indication of a network-node-selected resource skipping configuration (e.g., an updated network-node-selected resource skipping configuration). In some aspects, the network-node-selected resource skipping configuration may be based at least in part on the UE-selected resource skipping configuration, such as by including one or more configurations indicated by the UE-selected resource skipping configuration (e.g., a sliding window duration and/or UTO indication communication channel type) and/or including a reconfiguration that is based at least in part on the UE-selected resource skipping configuration. Alternatively, or additionally, the network node 110 may transmit an indication of an updated resource allocation that has been reconfigured based at least in part on the UE-selected resource skipping configuration to reduce resource waste. For instance, the reconfigured resource allocation may have a reduced number of transmission opportunities based at least in part on an applicability duration in the UE-selected resource skipping configuration indicating that an original resource allocation includes multiple unused transmission occasions. In some aspects, the resource allocation may have a resource skipping state as specified by the UE-selected resource skipping configuration (e.g., an enable resource skipping state and/or a disabled resource skipping state).

While the example 700 includes the network node 110 transmitting an updated network-node-selected resource skipping configuration, other examples may not include the network node 110 transmitting an updated network-node-selected resource skipping configuration. To illustrate, the UE 120 may autonomously adopt and/or begin using the UE-selected resource skipping configuration without receiving confirmation from the network node 110. For instance, the UE 120 may autonomously begin using the UE-selected resource skipping configuration after expiration of a timer.

As shown by reference number 780, the UE 120 may operate using the network-node-selected resource skipping configuration and/or the UE-selected resource skipping configuration. As one example, the UE 120 may transmit a UTO indication based at least in part on the network-node-selected resource skipping configuration and/or the UE-selected resource skipping configuration. The UE 120 may transmit the UTO indication using a PUSCH in one example, and may transmit the UTO indication using a PUCCH in another example. The UE 120 may not transmit a UTO indication for a first resource allocation that has resource skipping disabled, and/or may transit a UTO indication for a second resource allocation that has resource skipping enabled.

As operating conditions change at the UE 120, the UE 120 may generate an updated UE-selected resource skipping configuration. An example change in an operating condition may include a change in a data traffic profile. Accordingly, the UE 120 and/or the network node 110 may iteratively perform one or more of the transactions described with regard to the example 700.

Transmitting a UE-selected resource skipping configuration may increase a resource usage efficiency that results in increased data throughput and/or decreased data transfer delays in a wireless network. To illustrate, the UE may select the UE-selected resource skipping configuration using UE-local information that is unavailable to a network node, resulting in a UTO configuration that results in the UE using fewer air interface resources, reduces a delay in the UE providing a UTO indication to a network node, and/or increases reallocations performed by the network node. A UTO configuration that is based at least in part on a UE-selected resource skipping configuration may result in increased resource usage efficiency, increased data throughput, and/or decreased data transfer delays in a wireless network.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated UE-selected resource skipping configuration.

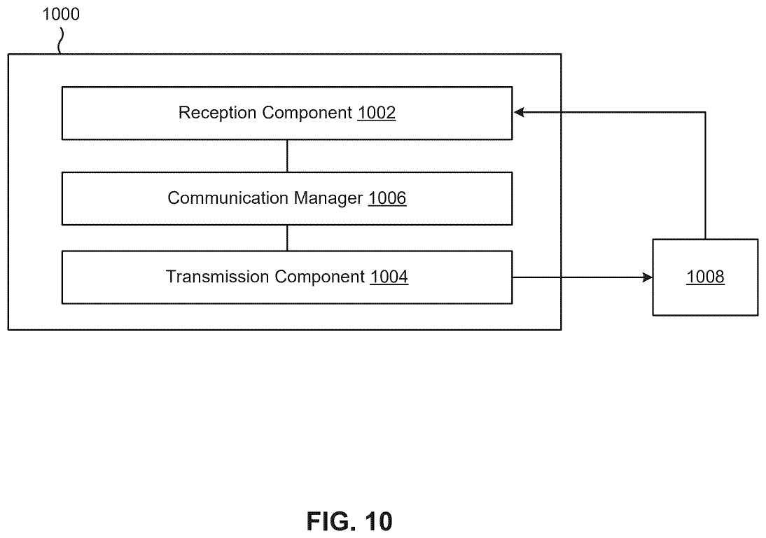

As shown in FIG. 8, in some aspects, process 800 may include receiving a first indication of one or more resource allocations that are assigned to the UE (block 810). For example, the UE (e.g., using reception component 1002 and/or communication manager 1006, depicted in FIG. 10) may receive a first indication of one or more resource allocations that are assigned to the UE, as described above.

As further shown in FIG. 8, in some aspects, process 800 may include transmitting a second indication of a UE-selected resource skipping configuration that is based at least in part on the one or more resource allocations (block 820). For example, the UE (e.g., using transmission component 1004 and/or communication manager 1006, depicted in FIG. 10) may transmit a second indication of a UE-selected resource skipping configuration that is based at least in part on the one or more resource allocations, as described above.

Process 800 may include additional aspects, such as any single aspect or any combination of aspects described below and/or in connection with one or more other processes described elsewhere herein.

In a first aspect, the one or more resource allocations comprise at least one of a dynamic uplink allocation, a configured grant uplink allocation, or a downlink grant allocation.

In a second aspect, the UE-selected resource skipping configuration indicates at least one of a selected resource allocation from the one or more resource allocations and an enabled resource skipping state for the selected resource allocation, an uplink channel for communicating a UTO indication, a UTO overlap state, a UTO indication communication type, a UTO indication resource unit type, or a UTO indication component carrier mode.

In a third aspect, process 800 includes receiving a network-node-selected resource skipping configuration that is based at least in part on the UE-selected resource skipping configuration, and transmitting a UTO indication based at least in part on the network-node-selected resource skipping configuration.

In a fourth aspect, the network-node-selected resource skipping configuration indicates at least one of a first resource allocation from the one or more resource allocations that has an enabled resource skipping state, or a second resource allocation from the one or more resource allocations that has a disabled resource skipping state.

In a fifth aspect, process 800 includes transmitting a UTO indication based at least in part on the UE-selected resource skipping configuration.

In a sixth aspect, transmitting the second indication of the UE-selected resource skipping configuration comprises transmitting the second indication of the UE-selected resource skipping configuration in an uplink MAC CE.

In a seventh aspect, the MAC CE includes a bitmap, and each bit of the bitmap is linked to a respective resource allocation of the one or more resource allocations.

In an eighth aspect, the second indication of the UE-selected resource skipping configuration is assistance information.

In a ninth aspect, the UE-selected resource skipping configuration indicates a duration for a UTO sliding window.

In a tenth aspect, the UE-selected resource skipping configuration indicates an enabled resource skipping state for two or more resource allocations of the one or more resource allocations, and a mapping of a respective UTO indication for each resource allocation of the two or more resource allocations.

In an eleventh aspect, each respective UTO indication comprises a bitmap, an SLIV, and the mapping indicates an interlacing of each respective UTO indication for the two or more resource allocations, the interlacing based at least in part on an initial occasion of the two or more resource allocations.

In a twelfth aspect, the UE-selected resource skipping configuration indicates an applicability duration of a UTO indication.

In a thirteenth aspect, process 800 includes receiving a third indication of one or more reconfigurations to the one or more resource allocations, the one or more reconfigurations being based at least in part on the applicability duration.

In a fourteenth aspect, the one or more resource allocations comprise a downlink resource allocation, and transmitting the second indication of the UE-selected resource skipping configuration comprises transmitting the second indication of the UE-selected resource skipping configuration based at least in part on a buffer status report.

In a fifteenth aspect, process 800 includes transmitting a UTO indication in an uplink MAC CE based at least in part on the UE-selected resource skipping configuration.

In a sixteenth aspect, process 800 includes transmitting a resource skipping capability that indicates support for UE-selected resource skipping.

In a seventeenth aspect, process 800 includes receiving, prior to transmitting the second indication of the UE-selected resource skipping configuration, a third indication of one or more allowed resource skipping parameters that are configurable by the UE, and the UE-selected resource skipping configuration is based at least in part on the one or more allowed resource skipping parameters.

In an eighteenth aspect, the one or more allowed resource skipping parameters are included in an information element.

In a nineteenth aspect, the UE-selected resource skipping configuration is based at least in part on a data traffic profile at the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with UE-selected resource skipping configuration.

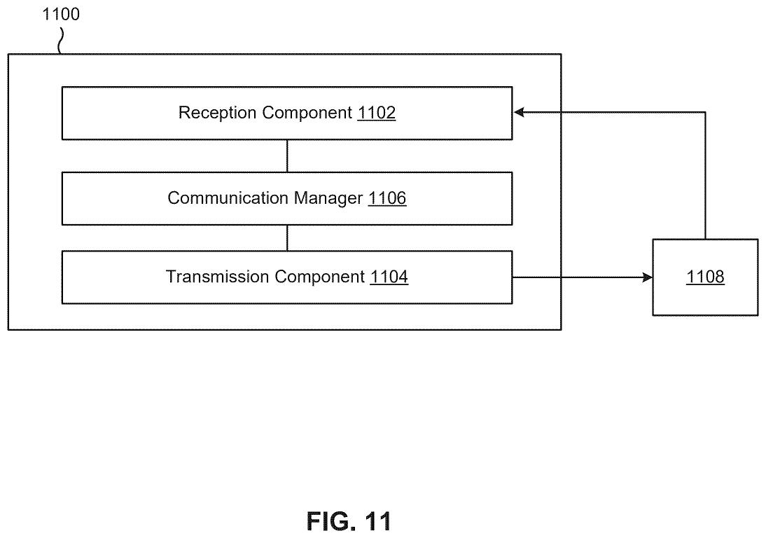

As shown in FIG. 9, in some aspects, process 900 may include transmitting a first indication of one or more resource allocations that are assigned to a UE (block 910). For example, the network node (e.g., using transmission component 1104 and/or communication manager 1106, depicted in FIG. 11) may transmit a first indication of one or more resource allocations that are assigned to a UE, as described above.

As further shown in FIG. 9, in some aspects, process 900 may include receiving a second indication of a UE-selected resource skipping configuration that is based at least in part on the one or more resource allocations (block 920). For example, the network node (e.g., using reception component 1102 and/or communication manager 1106, depicted in FIG. 11) may receive a second indication of a UE-selected resource skipping configuration that is based at least in part on the one or more resource allocations, as described above.

Process 900 may include additional aspects, such as any single aspect or any combination of aspects described below and/or in connection with one or more other processes described elsewhere herein.

In a first aspect, the one or more resource allocations comprise at least one of a dynamic uplink allocation, a configured grant uplink allocation, or a downlink grant allocation.

In a second aspect, the UE-selected resource skipping configuration indicates at least one of a selected resource allocation from the one or more resource allocations and an enabled resource skipping state for the selected resource allocation, an uplink channel for communicating a UTO indication, a UTO overlap state, a UTO indication communication type, a UTO indication resource unit type, or a UTO indication component carrier mode.

In a third aspect, process 900 includes transmitting a network-node-selected resource skipping configuration that is based at least in part on the UE-selected resource skipping configuration, and receiving a UTO indication based at least in part on the network-node-selected resource skipping configuration.

In a fourth aspect, the network-node-selected resource skipping configuration indicates at least one of a first resource allocation from the one or more resource allocations that has an enabled resource skipping state, or a second resource allocation from the one or more resource allocations that has a disabled resource skipping state.

In a fifth aspect, process 900 includes receiving a UTO indication based at least in part on the UE-selected resource skipping configuration.

In a sixth aspect, receiving the second indication of the UE-selected resource skipping configuration comprises receiving the second indication of the UE-selected resource skipping configuration in an uplink MAC CE.

In a seventh aspect, the MAC CE includes a bitmap, and each bit of the bitmap is linked to a respective resource allocation of the one or more resource allocations.

In an eighth aspect, the second indication of the UE-selected resource skipping configuration is assistance information.

In a ninth aspect, the UE-selected resource skipping configuration indicates a duration for a UTO sliding window.

In a tenth aspect, the UE-selected resource skipping configuration indicates an enabled resource skipping state for two or more resource allocations of the one or more resource allocations, and a mapping of a respective UTO indication for each resource allocation of the two or more resource allocations.

In an eleventh aspect, each respective UTO indication comprises a bitmap, an SLIV, and the mapping indicates an interlacing of each respective UTO indication for the two or more resource allocations, the interlacing based at least in part on an initial occasion of the two or more resource allocations.

In a twelfth aspect, the UE-selected resource skipping configuration indicates an applicability duration of a UTO indication.

In a thirteenth aspect, process 900 includes transmitting a third indication of one or more reconfigurations to the one or more resource allocations, the one or more reconfigurations being based at least in part on the applicability duration.

In a fourteenth aspect, process 900 includes receiving a UTO indication in an uplink MAC CE based at least in part on the UE-selected resource skipping configuration.

In a fifteenth aspect, process 900 includes receiving a resource skipping capability that indicates support for a UE-selected resource skipping.

In a sixteenth aspect, process 900 includes transmitting, prior to receiving the second indication of the UE-selected resource skipping configuration, a third indication of one or more resource skipping parameters that are configurable by the UE, and the UE-selected resource skipping configuration is based at least in part on the one or more resource skipping parameters.

In a seventeenth aspect, the one or more resource skipping parameters are included in an information element.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6A-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a first indication of one or more resource allocations that are assigned to the UE. The transmission component 1004 may transmit a second indication of a UE-selected resource skipping configuration that is based at least in part on the one or more resource allocations. Alternatively, or additionally, the reception component 1002 may receive a network-node-selected resource skipping configuration that is based at least in part on the UE-selected resource skipping configuration.

The transmission component 1004 may transmit a UTO indication based at least in part on the network-node-selected resource skipping configuration. Alternatively, or additionally, the transmission component 1004 may transmit a UTO indication based at least in part on the UE-selected resource skipping configuration.

The reception component 1002 may receive a third indication of one or more reconfigurations to the one or more resource allocations, the one or more reconfigurations being based at least in part on the applicability duration. In some aspects, the transmission component 1004 may transmit a UTO indication in an uplink MAC CE based at least in part on the UE-selected resource skipping configuration. Alternatively, or additionally, the transmission component 1004 may transmit a resource skipping capability that indicates support for UE-selected resource skipping.

The reception component 1002 may receive, prior to transmitting the second indication of the UE-selected resource skipping configuration, a third indication of one or more allowed resource skipping parameters that are configurable by the UE, and the UE-selected resource skipping configuration is based at least in part on the one or more allowed resource skipping parameters.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6A-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a first indication of one or more resource allocations that are assigned to a UE. The reception component 1102 may receive a second indication of a UE-selected resource skipping configuration that is based at least in part on the one or more resource allocations.

The transmission component 1104 may transmit a network-node-selected resource skipping configuration that is based at least in part on the UE-selected resource skipping configuration. In some aspects, the reception component 1102 may receive a UTO indication based at least in part on the network-node-selected resource skipping configuration. Alternatively, or additionally, the reception component 1102 may receive a UTO indication based at least in part on the UE-selected resource skipping configuration.

The transmission component 1104 may transmit a third indication of one or more reconfigurations to the one or more resource allocations, the one or more reconfigurations being based at least in part on the applicability duration. In some aspects, the reception component 1102 may receive a UTO indication in an uplink MAC CE based at least in part on the UE-selected resource skipping configuration. Alternatively, or additionally, the reception component 1102 may receive a resource skipping capability that indicates support for a UE-selected resource skipping. In some aspects, the transmission component 1104 may transmit, prior to receiving the second indication of the UE-selected resource skipping configuration, a third indication of one or more resource skipping parameters that are configurable by the UE, and the UE-selected resource skipping configuration is based at least in part on the one or more resource skipping parameters.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a first indication of one or more resource allocations that are assigned to the UE; and transmitting a second indication of a UE-selected resource skipping configuration that is based at least in part on the one or more resource allocations.

Aspect 2: The method of Aspect 1, wherein the one or more resource allocations comprise at least one of: a dynamic uplink allocation, a configured grant uplink allocation, or a downlink grant allocation.

Aspect 3: The method of any of Aspects 1-2, wherein the UE-selected resource skipping configuration indicates at least one of: a selected resource allocation from the one or more resource allocations and an enabled resource skipping state for the selected resource allocation, an uplink channel for communicating an unused transmission occasion (UTO) indication, a UTO overlap state, a UTO indication communication type, a UTO indication resource unit type, or a UTO indication component carrier mode.

Aspect 4: The method of any of Aspects 1-3, further comprising: receiving a network-node-selected resource skipping configuration that is based at least in part on the UE-selected resource skipping configuration; and transmitting an unused transmission occasion (UTO) indication based at least in part on the network-node-selected resource skipping configuration.

Aspect 5: The method of Aspect 4, wherein the network-node-selected resource skipping configuration indicates at least one of: a first resource allocation from the one or more resource allocations that has an enabled resource skipping state, or a second resource allocation from the one or more resource allocations that has a disabled resource skipping state.

Aspect 6: The method of any of Aspects 1-5, further comprising: transmitting an unused transmission occasion (UTO) indication based at least in part on the UE-selected resource skipping configuration.

Aspect 7: The method of any of Aspects 1-6, wherein transmitting the second indication of the UE-selected resource skipping configuration comprises: transmitting the second indication of the UE-selected resource skipping configuration in an uplink medium access control (MAC) control element (CE).

Aspect 8: The method of Aspect 7, wherein the MAC CE includes a bitmap, and wherein each bit of the bitmap is linked to a respective resource allocation of the one or more resource allocations.

Aspect 9: The method of any of Aspects 1-8, wherein the second indication of the UE-selected resource skipping configuration is assistance information.

Aspect 10: The method of any of Aspects 1-9, wherein the UE-selected resource skipping configuration indicates a duration for an unused transmission occasion (UTO) sliding window.

Aspect 11: The method of any of Aspects 1-10, wherein the UE-selected resource skipping configuration indicates: an enabled resource skipping state for two or more resource allocations of the one or more resource allocations, and a mapping of a respective unused transmission occasion (UTO) indication for each resource allocation of the two or more resource allocations.

Aspect 12: The method of Aspect 11, wherein each respective UTO indication comprises: a bitmap, a start and length indicator value (SLIV); and wherein the mapping indicates an interlacing of each respective UTO indication for the two or more resource allocations, the interlacing based at least in part on an initial occasion of the two or more resource allocations.

Aspect 13: The method of any of Aspects 1-12, wherein the UE-selected resource skipping configuration indicates an applicability duration of an unused transmission occasion (UTO) indication.

Aspect 14: The method of Aspect 13, further comprising: receiving a third indication of one or more reconfigurations to the one or more resource allocations, the one or more reconfigurations being based at least in part on the applicability duration.

Aspect 15: The method of any of Aspects 1-14, wherein the one or more resource allocations comprise a downlink resource allocation, and wherein transmitting the second indication of the UE-selected resource skipping configuration comprises: transmitting the second indication of the UE-selected resource skipping configuration based at least in part on a buffer status report.

Aspect 16: The method of any of Aspects 1-15, further comprising: transmitting an unused transmission occasion (UTO) indication in an uplink medium access control (MAC) control element (CE) based at least in part on the UE-selected resource skipping configuration.

Aspect 17: The method of any of Aspects 1-16, further comprising: transmitting a resource skipping capability that indicates support for UE-selected resource skipping.

Aspect 18: The method of any of Aspects 1-17, further comprising: receiving, prior to transmitting the second indication of the UE-selected resource skipping configuration, a third indication of one or more allowed resource skipping parameters that are configurable by the UE, wherein the UE-selected resource skipping configuration is based at least in part on the one or more allowed resource skipping parameters.

Aspect 19: The method of Aspect 18, wherein the one or more allowed resource skipping parameters are included in an information element.

Aspect 20: The method of any of Aspects 1-19, wherein the UE-selected resource skipping configuration is based at least in part on a data traffic profile at the UE.

Aspect 21: A method of wireless communication performed by a network node, comprising: transmitting a first indication of one or more resource allocations that are assigned to a user equipment (UE); and receiving a second indication of a UE-selected resource skipping configuration that is based at least in part on the one or more resource allocations.

Aspect 22: The method of Aspect 21, wherein the one or more resource allocations comprise at least one of: a dynamic uplink allocation, a configured grant uplink allocation, or a downlink grant allocation.

Aspect 23: The method of any of Aspects 21-22, wherein the UE-selected resource skipping configuration indicates at least one of: a selected resource allocation from the one or more resource allocations and an enabled resource skipping state for the selected resource allocation, an uplink channel for communicating an unused transmission occasion (UTO) indication, a UTO overlap state, a UTO indication communication type, a UTO indication resource unit type, or a UTO indication component carrier mode.

Aspect 24: The method of any of Aspects 21-23, further comprising: transmitting a network-node-selected resource skipping configuration that is based at least in part on the UE-selected resource skipping configuration; and receiving an unused transmission occasion (UTO) indication based at least in part on the network-node-selected resource skipping configuration.

Aspect 25: The method of Aspect 24, wherein the network-node-selected resource skipping configuration indicates at least one of: a first resource allocation from the one or more resource allocations that has an enabled resource skipping state, or a second resource allocation from the one or more resource allocations that has a disabled resource skipping state.

Aspect 26: The method of any of Aspects 21-25, further comprising: receiving an unused transmission occasion (UTO) indication based at least in part on the UE-selected resource skipping configuration.

Aspect 27: The method of any of Aspects 21-26, wherein receiving the second indication of the UE-selected resource skipping configuration comprises: receiving the second indication of the UE-selected resource skipping configuration in an uplink medium access control (MAC) control element (CE).

Aspect 28: The method of Aspect 27, wherein the MAC CE includes a bitmap, and wherein each bit of the bitmap is linked to a respective resource allocation of the one or more resource allocations.

Aspect 29: The method of any of Aspects 21-28, wherein the second indication of the UE-selected resource skipping configuration is assistance information.

Aspect 30: The method of any of Aspects 21-29, wherein the UE-selected resource skipping configuration indicates a duration for an unused transmission occasion (UTO) sliding window.

Aspect 31: The method of any of Aspects 21-30, wherein the UE-selected resource skipping configuration indicates: an enabled resource skipping state for two or more resource allocations of the one or more resource allocations, and a mapping of a respective unused transmission occasion (UTO) indication for each resource allocation of the two or more resource allocations.

Aspect 32: The method of Aspect 31, wherein each respective UTO indication comprises: a bitmap, a start and length indicator value (SLIV); and wherein the mapping indicates an interlacing of each respective UTO indication for the two or more resource allocations, the interlacing based at least in part on an initial occasion of the two or more resource allocations.

Aspect 33: The method of any of Aspects 21-32, wherein the UE-selected resource skipping configuration indicates an applicability duration of an unused transmission occasion (UTO) indication.

Aspect 34: The method of Aspect 33, further comprising: transmitting a third indication of one or more reconfigurations to the one or more resource allocations, the one or more reconfigurations being based at least in part on the applicability duration.

Aspect 35: The method of any of Aspects 21-34, further comprising: receiving an unused transmission occasion (UTO) indication in an uplink medium access control (MAC) control element (CE) based at least in part on the UE-selected resource skipping configuration.

Aspect 36: The method of any of Aspects 21-35, further comprising: receiving a resource skipping capability that indicates support for a UE-selected resource skipping.

Aspect 37: The method of any of Aspects 21-36, further comprising: transmitting, prior to receiving the second indication of the UE-selected resource skipping configuration, a third indication of one or more resource skipping parameters that are configurable by the UE, wherein the UE-selected resource skipping configuration is based at least in part on the one or more resource skipping parameters.

Aspect 38: The method of Aspect 37, wherein the one or more resource skipping parameters are included in an information element.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 40: An apparatus for wireless communication at a device, the apparatus comprising one or more memories and one or more processors coupled to the one or more memories, the one or more processors configured to cause the device to perform the method of one or more of Aspects 1-20.

Aspect 41: An apparatus for wireless communication, the apparatus comprising at least one means for performing the method of one or more of Aspects 1-20.

Aspect 42: A non-transitory computer-readable medium storing code for wireless communication, the code comprising instructions executable by one or more processors to perform the method of one or more of Aspects 1-20.

Aspect 43: A non-transitory computer-readable medium storing a set of instructions for wireless communication, the set of instructions comprising one or more instructions that, when executed by one or more processors of a device, cause the device to perform the method of one or more of Aspects 1-20.

Aspect 44: A device for wireless communication, the device comprising a processing system that includes one or more processors and one or more memories coupled with the one or more processors, the processing system configured to cause the device to perform the method of one or more of Aspects 1-20.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 21-38.

Aspect 47: An apparatus for wireless communication at a device, the apparatus comprising one or more memories and one or more processors coupled to the one or more memories, the one or more processors configured to cause the device to perform the method of one or more of Aspects 21-38.

Aspect 48: An apparatus for wireless communication, the apparatus comprising at least one means for performing the method of one or more of Aspects 21-38.

Aspect 49: A non-transitory computer-readable medium storing code for wireless communication, the code comprising instructions executable by one or more processors to perform the method of one or more of Aspects 21-38.

Aspect 50: A non-transitory computer-readable medium storing a set of instructions for wireless communication, the set of instructions comprising one or more instructions that, when executed by one or more processors of a device, cause the device to perform the method of one or more of Aspects 21-38.

Aspect 51: A device for wireless communication, the device comprising a processing system that includes one or more processors and one or more memories coupled with the one or more processors, the processing system configured to cause the device to perform the method of one or more of Aspects 21-38.

Aspect 52: An apparatus for wireless communication at a device, the apparatus comprising one or more memories and one or more processors coupled to the one or more memories, the one or more processors individually or collectively configured to cause the device to perform the method of one or more of Aspects 21-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a first indication of one or more resource allocations that are assigned to the UE; and
transmit a second indication of a UE-selected resource skipping configuration that is based at least in part on the one or more resource allocations.

2. The apparatus of claim 1, wherein the UE-selected resource skipping configuration indicates at least one of:
a selected resource allocation from the one or more resource allocations and an enabled resource skipping state for the selected resource allocation,
an uplink channel for communicating an unused transmission occasion (UTO) indication,
a UTO overlap state,
a UTO indication communication type,
a UTO indication resource unit type, or
a UTO indication component carrier mode.

3. The apparatus of claim 1, wherein the one or more processors are further configured to cause the UE to:
receive a network-node-selected resource skipping configuration that is based at least in part on the UE-selected resource skipping configuration; and
transmit an unused transmission occasion (UTO) indication based at least in part on the network-node-selected resource skipping configuration.

4. The apparatus of claim 1, wherein the one or more processors are further configured to cause the UE to:
transmit an unused transmission occasion (UTO) indication based at least in part on the UE-selected resource skipping configuration.

5. The apparatus of claim 1, wherein the one or more processors, to cause the UE to transmit the second indication of the UE-selected resource skipping configuration, are configured to cause the UE to:
transmit the second indication of the UE-selected resource skipping configuration in an uplink medium access control (MAC) control element (CE).

6. The apparatus of claim 1, wherein the UE-selected resource skipping configuration indicates a duration for an unused transmission occasion (UTO) sliding window.

7. The apparatus of claim 1, wherein the UE-selected resource skipping configuration indicates:
an enabled resource skipping state for two or more resource allocations of the one or more resource allocations, and
a mapping of a respective unused transmission occasion (UTO) indication for each resource allocation of the two or more resource allocations.

8. The apparatus of claim 1, wherein the UE-selected resource skipping configuration indicates an applicability duration of an unused transmission occasion (UTO) indication.

9. The apparatus of claim 1, wherein the one or more resource allocations comprise a downlink resource allocation, and
wherein the one or more processors, to cause the UE to transmit the second indication of the UE-selected resource skipping configuration, are configured to cause the UE to:
transmit the second indication of the UE-selected resource skipping configuration based at least in part on a buffer status report.

10. The apparatus of claim 1, wherein the one or more processors are further configured to cause the UE to:
transmit a resource skipping capability that indicates support for UE-selected resource skipping.

11. The apparatus of claim 1, wherein the one or more processors are further configured to cause the UE to:
receive, prior to transmitting the second indication of the UE-selected resource skipping configuration, a third indication of one or more allowed resource skipping parameters that are configurable by the UE,
wherein the UE-selected resource skipping configuration is based at least in part on the one or more allowed resource skipping parameters.

12. The apparatus of claim 1, wherein the UE-selected resource skipping configuration is based at least in part on a data traffic profile at the UE.

13. A method of wireless communication performed by a user equipment (UE), comprising:
receiving a first indication of one or more resource allocations that are assigned to the UE; and
transmitting a second indication of a UE-selected resource skipping configuration that is based at least in part on the one or more resource allocations.

14. The method of claim 13, wherein the UE-selected resource skipping configuration indicates at least one of:
a selected resource allocation from the one or more resource allocations and an enabled resource skipping state for the selected resource allocation,
an uplink channel for communicating an unused transmission occasion (UTO) indication,
a UTO overlap state,
a UTO indication communication type,
a UTO indication resource unit type, or
a UTO indication component carrier mode.

15. The method of claim 13, further comprising:
transmitting an unused transmission occasion (UTO) indication based at least in part on the UE-selected resource skipping configuration.

16. The method of claim 13, wherein transmitting the second indication of the UE-selected resource skipping configuration comprises:
transmitting the second indication of the UE-selected resource skipping configuration in an uplink medium access control (MAC) control element (CE).

17. The method of claim 16, wherein the MAC CE includes a bitmap, and
wherein each bit of the bitmap is linked to a respective resource allocation of the one or more resource allocations.

18. A non-transitory computer-readable medium storing a set of instructions for wireless communication, the set of instructions comprising:
one or more instructions that, when executed by one or more processors of a user equipment (UE), cause the UE to:
receive a first indication of one or more resource allocations that are assigned to the UE; and
transmit a second indication of a UE-selected resource skipping configuration that is based at least in part on the one or more resource allocations.

19. The non-transitory computer-readable medium of claim 18, wherein the UE-selected resource skipping configuration indicates at least one of:
a selected resource allocation from the one or more resource allocations and an enabled resource skipping state for the selected resource allocation,
an uplink channel for communicating an unused transmission occasion (UTO) indication,
a UTO overlap state,
a UTO indication communication type,
a UTO indication resource unit type, or
a UTO indication component carrier mode.

20. The non-transitory computer-readable medium of claim 18, wherein the one or more instructions further cause the UE to:
receive, prior to transmitting the second indication of the UE-selected resource skipping configuration, a third indication of one or more allowed resource skipping parameters that are configurable by the UE,
wherein the UE-selected resource skipping configuration is based at least in part on the one or more allowed resource skipping parameters.
